(19) United States
(12) Patent Application Publication
(10) Pub. No.: US 2003/0152791 A1
(43) Pub. Date: Aug. 14, 2003

(54) Extruded multilayer film structure including an ethylene acid terpolymer layer for improved heat seal and metal adhesion

(76) Inventor: Pang-Chia Lu, Pittsford, NY (US)

Correspondence Address: EXXONMOBIL CHEMICAL COMPANY, P O BOX 2149, BAYTOWN, TX, 77522-2149, US

(21) Appl. No.: 10/072,575

(22) Filed: Feb. 8, 2002

(51) Int. Cl. B32B 27/08

(52) U.S. Cl. 428/515; 428/521; 428/523

(57) ABSTRACT

The present invention relates to a multilayer polymer film structure that possesses the necessary functionality to serve as either (i) a heat sealable film with low minimum seal temperature, broad seal range, and high seal strength or (ii) a metal-receiving film onto which a metal layer may be deposited with excellent metal adhesion. The film structure includes a core layer and at least one skin layer. The core layer has a first and second side, and contains a film-forming polyolefin. The at least one skin layer contains a film-forming ethylene acid terpolymer resin composition comprising (i) polyethylene, (ii) acrylic acid, methacrylic acid, or mixtures thereof, and (iii) alkyl acrylate, alkyl methacrylate, or mixtures thereof. The film is particularly useful in the packaging of certain types of foods.

### BACKGROUND

The invention relates to polymer films. In particular, the invention relates to a multilayer polymer film structure that possesses the necessary functionality to serve as either (i) a heat sealable film with low minimum seal temperature, broad seal range, and high seal strength or (ii) a metal-receiving film onto which a metal layer may be deposited with excellent metal adhesion.

In the packaging of certain types of foods, such as cookies, potato chips, and the like, it is common practice to employ a multilayer film having two or more polymeric layers wherein one of the layers is known to be an effective heat seal layer. In the packaging process, a supply of such a multilayer film can be shaped into a tube in a vertical form and fill machine. Marginal regions of the heat seal layer are brought into a face-to-face relationship and heat sealed together. Thereafter, the packaging machine automatically forms a heat seal and makes a horizontal severance across the bottom of the bag. Next, product is dispensed into the open end of the tube and, thereafter, a second horizontal seal is effected across the tube with a simultaneous severing through the tube to result in a product packaged in a tube, heat sealed at both ends and along one seam at right angles to the end seals. While the food or other product is being dispensed into the package, air is also present in the package and this air assists in protecting and cushioning the product during subsequent shipment of the finished packages.

During the package formation, film structures having a relatively high minimum heat seal temperature may force higher heat settings on the sealing bar, which can be problematic when running products that melt, such as chocolate. Furthermore, during shipment of the product, and particularly with larger size bags containing, for example, 6 ounces or more of product, the bags have a tendency to split or burst at the end seals. Accordingly, a need exists for multilayer film structures having improved heat seal properties.

Additionally, multilayer film structures used in food packaging often have a metal coating layer deposited on an exposed surface of the film structure in order to hinder the onset of rancidity of the enclosed products by reducing the passage of oxygen, moisture, and visible and ultraviolet lights. Unfortunately, the metal to film bonding can be weak or even fail in many applications due to the constitution of the film structure, thereby causing the metal to be removed from the film and reducing the barrier properties. Accordingly, a need exists for metallized multilayer film structures exhibiting improved adhesion between the metal coating layer and the film structure.

U.S. Pat. No. 5,500,283 to Kirk, et al. discloses a coated film composition comprising a coating that may be derived from a terpolymeric composition comprising an α,β-monoethylenically-unsaturated carboxylic acid and a neutral monomer ester.

U.S. Pat. No. 5,827,615 to Touhsaent, et al. discloses a metallized multilayer packaging film comprising a coating comprising a base copolymer of an α,β-ethylenically unsaturated carboxylic acid with ethylene, an alkyl acrylate or methacrylate, acrylonitrile, or mixtures thereof.

### SUMMARY

There is provided a multilayer film structure comprising a polymer substrate, the polymer substrate comprising:

(a) a core layer comprising a film-forming polyolefin, the core layer having a first side and a second side; and

(b) a skin layer on the first side of the core layer, wherein the skin layer comprises a film-forming ethylene acid terpolymer resin composition comprising (i) polyethylene, (ii) acrylic acid, methacrylic acid, or mixtures thereof, and (iii) alkyl acrylate, alkyl methacrylate, or mixtures thereof.

In one embodiment of the invention, the multilayer film structure may serve as a heat sealable film structure having (i) a reduced minimum seal temperature that permits heat sealing at lower temperatures and (ii) high seal strength. The ability to heat seal at lower temperatures is advantageous in that it provides a wider seal range and lower heat settings on the sealing bar, which is especially advantageous when running products that melt, such as chocolate.

In another embodiment of the invention, the polymer substrate of the multilayer film structure may serve as a metal-receiving polymer substrate, in which case a metal layer may be deposited on the skin layer (b) of the polymer substrate, the metal layer being deposited on the surface of the skin layer opposite the core layer, i.e. on an exposed or outermost surface of the skin layer.

### DETAILED DESCRIPTION

The multilayer film structure includes a core layer. The core layer comprises a film-forming polyolefin which has properties suitable for extrusion or coextrusion followed by uniaxial or biaxial orientation (by stretching the extrudate in the machine direction and/or transverse direction) under elevated temperatures so as to form a film. The film-forming polyolefin may be a propylene homopolymer or a propylene copolymer, ie. a polyolefin made predominantly of propylene with minor amounts of another olefin, usually a C₂-C₄ olefin. For example, the film-forming polyolefin may be an isotactic propylene homopolymer which has an isotacticity of from about 93% to about 99%, a crystallinity of from about 70% to about 80%, and a melting point of about 145° C. or higher, e.g. up to about 167° C. An example of a commercially available propylene homopolymer that may be used as the present core layer is the resin 3371, available from FINA.

Alternatively, the film-forming polyolefin of the core layer may be a polyethylene. For example, the film-forming polyolefin of the core layer may be a high density polyethylene (HDPE) or a linear low density polyethylene (LLDPE). HDPE is a substantially linear polyolefin having a density of, for example, from about 0.952 g/cm³ or higher, e.g. from about 0.952 g/cm³ to about 0.962 g/cm³, and a melting point of, for example, from about 130° C. to about 148° C. LLDPE has a density in the range of from 0.90 g/cm³ to 0.94 g/cm³, e.g. from 0.910 g/cm³ to 0.926 g/cm³, and a melt index of from about 1 to about 10 g/10 min. LLDPE may be derived from ethylene together with a minor amount of a higher olefin comonomer containing 4 to 10 carbon atoms, e.g., butene-1, hexene-1, or oxene-1.

If it is desired to produce a film which is opaque after being subjected to uniaxial or biaxial orientation as described hereinafter, microspheres may optionally be dispersed in the core layer polymer before extrusion and orientation of the film. When a film containing such a core layer is subjected to uniaxial or biaxial orientation, a cavity forms around each microsphere giving the oriented film an opaque appearance.

Such microspheres, which may be any of those disclosed, for example, in U.S. Pat. Nos. 4,377,616 and 4,632,869, the entire disclosures of which are incorporated herein by reference, are composed of a material higher melting than, and immiscible with, the film-forming polyolefin of the core layer. Thus, the microspheres may be composed of a polymer, e.g., a polyester such as polybutylene terephthalate (PBT) or polyethylene terephthalate (PET), a nylon, an acrylic resin, or polystyrene, or an inorganic material such as glass, metal or ceramic. The preferred material for the microspheres is PBT. The particle size of the microspheres may be, for example, about 0.1 to 10 microns, preferably about 0.75 to 2 microns. The microspheres may be present in the core layer in an amount of up to about 20 wt %, preferably from about 4 to about 12 wt %, based on the total weight of the core layer.

The core layer may optionally comprise one or more hydrocarbon resins. The hydrocarbon resin(s) may be present in the core layer in a total amount of from 5 wt % to 30 wt %, for example, from 5 wt % to 25 wt %, e.g., from 10 wt % to 20 wt %, based upon the total weight of the core layer.

The hydrocarbon resin(s) may be a low molecular weight hydrocarbon which is compatible with the film-forming polyolefin of the core layer. The hydrocarbon resin(s) may, optionally, be hydrogenated. The hydrocarbon resin(s) may have a number average molecular weight of less than 5,000, for example, less than 2,000, e.g., from 500 to 1,000. The hydrocarbon resin(s) may be natural or synthetic and may have a softening point in the range of from 60° C. to 180° C. Examples of a hydrocarbon resin that may be contained in the present core layer include any of the hydrocarbon resins disclosed in U.S. Pat. No. 5,667,902 to Brew, et al. and in U.S. Pat. No. 5,529,843 to Dries, et al. Specific examples include, but are not limited to, petroleum resins, terpene resins, styrene resins, and cyclopentadiene resins. Examples of commercially available hydrogenated resins include PICCOLYTE, REGALREZ, and REGALITE, each of which are available from Hercules Corp., and ESCOREZ, available from ExxonMobil Chemical Co. Particularly preferred resins are Exxon 6114E1 and Exxon 6114E2.

The hydrocarbon resin(s) may be a modified hydrocarbon resin. The modification may be effected in general by reacting the raw materials before the polymerization, by introducing special monomers or by reacting the polymerized product. Preferably hydrogenations or partial hydrogenations are carried out to modify the hydrocarbon resin(s).

A particular type of hydrocarbon resin that may be included in the core layer is a saturated alicyclic resin. Saturated alicyclic resins may have a softening point in the range of from 85° C. to 140° C., for example from 100° C. to 140° C., as measured by the ring and ball technique. An example of a commercially available saturated alicyclic resin is ARKON-P, available from Arakawa Forest Chemical Industries, Ltd. of Japan.

A saturated alicyclic hydrocarbon resins may be obtained by the hydrogenation of an aromatic hydrocarbon resin. The aromatic resin is obtained by polymerizing reactive unsaturated hydrocarbons containing aromatic hydrocarbons in which reactive double bonds are generally in side-chains. The saturated alicyclic resin is obtained from the aromatic resin by hydrogenating the latter until all, or most all, of the unsaturation has disappeared, including the double bonds in the aromatic rings. Although the aromatic hydrocarbons useful in the preparation of the alicyclic resins are mainly compounds containing reactive double bonds in side-chains, they may also comprise hydrocarbons having reactive double bonds in condensed ring systems. Examples of such useful aromatic hydrocarbons include vinyltoluene, vinylxylene, propenylbenzene, styrene, methylstyrene, indene, methylindene and ethylindene. Mixtures of these hydrocarbons may be used.

The core layer may also optionally comprise one or more migratory slip/anti-block and anti-static agents, such as amides, stearates, and amines, which are commonly referred to in the art as migratory slip additives. Such additives can be used in quantities of up to about 1.0% by weight and preferably from about 0.05% to about 0.5% by weight of the core layer. The use of these additives, however, may be limited by their propensity to deaden adhesion in the end use application. As an example, the core layer may include between 0 and 10,000 ppm of at least one of: saturated and unsaturated amides having from 16 to 22 carbon atoms; stearates, particularly zinc stearate and calcium stearate; silicone oil; glycerol monostearate; amines; and finely divided inorganic particles.

Other additives, such as pigments and fillers, may also be included in the core layer.

The multilayer film structure includes a skin layer (b) on the first side of the core layer. The skin layer (b) may comprise a film-forming ethylene acid terpolymer resin composition comprising (i) polyethylene, (ii) acrylic acid, methacrylic acid, or mixtures thereof, and (iii) alkyl acrylate, alkyl methacrylate, or mixtures thereof. For example, the ethylene acid terpolymer resin composition may comprise: (i) from about 0.5 wt % to about 6 wt % of acrylic acid, methacrylic acid, or mixtures thereof; (ii) from about 6 wt % to about 20 wt % of alkyl acrylate, alkyl methacrylate, or mixtures thereof; and (iii) the remainder of polyethylene. Examples of ethylene acid terpolymer resins that may be used as the skin layer include ESCOR AT-310 and ESCOR AT-320, available from ExxonMobil Chemical.

In a particular embodiment, the multilayer film structure may include a second skin layer (c) on the second side of the core layer.

Skin layer (c) may comprise a homopolymer of propylene, or a homopolymer of ethylene, including linear low density polyethylene (LLDPE), low density polyethylene (LDPE), medium density polyethylene (MDPE), high density polyethylene (HDPE) or blends thereof. An example of a commercially available polyethylene resin that may be used as the present skin layer (c) is M-6030, available from LYONDELL.

Alternatively, skin layer (c) may comprise polyolefinic copolymers, terpolymers, or blends thereof. Suitable copolymers include copolymers of propylene and butene-1, block copolymers of, for example, ethylene and propylene, and random copolymers of, for example, ethylene and propylene. The terpolymers may be exemplified by ethylene-propylene-butene-1 terpolymers, and are particularly preferred.

Also, other heat sealable blends may be utilized in providing skin layer (c). Thus, along with the copolymer or terpolymer there can be polypropylene homopolymer, or any other material which does not impair the heat sealability of this layer.

Suitable ethylene-propylene-butene-1 (EPB) terpolymers for skin layer (c) are those obtained from the random inter-polymerization of from about 1 to about 8 weight percent ethylene, preferably from about 3 to about 7 weight percent ethylene with from about 1 to about 10 weight percent butene-1, preferably from about 2 to about 8 weight percent butene-1 with propylene representing the balance. The foregoing EPB terpolymers may be characterized by a melt index at 230° C. of from about 2 to about 16 and advantageously from about 3 to about 7, a crystalline melting point of from about 100° C. to about 140° C., an average molecular weight of from about 25,000 to about 100,000 and a density within the range of from about 0.89 to about 0.92 g/cm³. An example of a commercially available terpolymer that may be used as the present skin layer (c) is XPM 7510, available from CHISSO.

Suitable ethylene-propylene (EP) random copolymers for skin layer (c) generally contain from about 2 to about 8 wt % ethylene, specifically from about 3 to about 7 wt % ethylene, the balance being made up of propylene. The copolymers may have a melt index at 230° C. generally ranging from about 2 to about 15 and preferably from about 3 to about 8. The crystalline melting point is usually from about 125° C. to about 150° C. and the number average molecular weight range is from about 25,000 to 100,000. The density will usually range from about 0.89 to about 0.92 g/cm³. An example of a commercially available copolymer that may be used as the present skin layer (c) is 7880 PP, available from CHISSO.

Suitable propylene-butene-1 copolymers include Cefor SRD4-105 and Cefor SRD4-104, which are available from Shell Chemical Co.

In general, when blends of EPB terpolymer and EP random copolymer are used, such blends will contain from about 10 to about 90 weight percent EPB terpolymer and preferably from about 40 to about 60 weight percent EPB terpolymer, the balance being made up of EP random copolymer.

In embodiments wherein the multilayer film structure includes a second skin layer (c) on the second side of the core layer, the skin layer (b) comprising a film-forming ethylene acid terpolymer resin composition is referred to as the first skin layer. Any reference herein to a “skin layer” is intended to mean the skin layer (b) on the first side of the core layer comprising a film-forming ethylene acid terpolymer resin composition, i.e. the first skin layer, unless specifically noted otherwise.

The combination of (i) the core layer, (ii) the skin layer (b) on the first side of the core layer, and (iii) the second skin layer (c) on the second side of the core layer (in embodiments including a second skin layer (c) on the second side of the core layer), may be termed the polymer substrate of the multilayer film structure.

Skin layer (b), which may comprise a film-forming ethylene acid terpolymer resin composition, is not coated onto the core layer as a solvent solution, or as a solvent-less coating, by coating application methods, such as, for example, rod, direct gravure (forward and reverse), offset gravure, slot die, air knife, roll, dipping, or spraying in order to form the polymer substrate of the multilayer film structure.

Instead, skin layer (b) may be coextruded with the core layer such that the polymer substrate of the multilayer film structure may be prepared by coextruding the particular polymers of each particular layer. After extruding the polymer substrate using conventional coextrusion techniques, the polymer substrate may be heated and molecularly oriented in the longitudinal, i.e. machine, direction and, optionally, in the transverse direction. This uniaxial or biaxial orientation, which greatly improves the stiffness and tensile strength properties of the polymer substrate, is accomplished by using conventional techniques to sequentially or simultaneously stretch the substrate from, for example, about 2 to 8 times in the machine direction and, optionally, from about 5 to 12 times in the transverse direction, at a drawing temperature of from about 100° C. to about 200° C. For further information concerning biaxial orientation, see, for example, U.S. Pat. No. 5,885,721.

Alternatively, the polymer substrate of the multilayer film structure may be prepared by extruding the core layer first and then heating the core layer and orienting the core layer in the longitudinal, or machine, direction. Thereafter, skin layer (b) may be extruded onto the first side of the machine direction-oriented core layer, and skin layer (b) and the machine direction-oriented core layer may then be oriented in the transverse direction. In this alternative, the second skin layer (c), if present, may be coextruded with the core layer prior to machine direction orientation or it may be extruded onto the second side of the core layer after the core layer has been oriented in the machine direction.

In short, the film-forming ethylene acid terpolymer resin of skin layer (b) is distinct from prior art ethylene (meth)acrylic acid compositions, such as those described in the '283 and '615 patents discussed herein above.

As mentioned above, the film-forming ethylene acid terpolymer resin of skin layer (b) is a coextrudable or extrudable film-forming resin. The film-forming ethylene acid terpolymer resin may be generally described as an extrusion-grade material that is semi-crystalline on account of its relatively high ethylene content. The film-forming ethylene acid terpolymer resin may have a melting point of about 70° C. or higher. Moreover, the film-forming ethylene acid terpolymer resin should have a relatively high molecular weight so as to maintain the rheology in the molten state for viscosity and elasticity control in an extruder. For example, the film-forming ethylene acid terpolymer resin may have a molecular weight of from 50,000 to 1 million, e.g., from about 55,000 to 1 million.

The prior art coating compositions, on the other hand, comprise so-called emulsion polymers, such as a coating-grade acrylate copolymer. The composition is a solution or fine dispersion that is coated onto a layer by gravure coating, roll coating, dipping, spraying, etc. The excess solution is removed by squeeze rolls, doctor knives, etc.

A typical coating-grade acrylate copolymer may have no olefin, e.g., ethylene, component. A typical coating-grade acrylate copolymer is obtained from one each of various acrylates and acrylic acids to give a compound having a low glass transition temperature T_{g}. For example, a typical coating-grade acrylate copolymer may be an acrylic latex, which contains acrylic ester monomers and acrylic acid monomers with no olefin monomer. Because typical coating-grade acrylate copolymers are amorphous materials, they are not extrudable (will degrade), and have a low T_{g} and melting point. Typical coating-grade acrylate copolymer with no olefin component are easily produced in water solution directly and used as is.

Other coating-grade acrylate copolymers may have an olefin component. Coating-grade acrylate copolymers that have an olefin component are prepared in a solvent carrier or dry, and are then produced as dry resin pellets. To disperse the dry resin pellet, the molecular weight of the pellet must be sufficiently low (depending on the functional group and its affinity to water) to be emulsified in water. A typical coating-grade acrylate copolymer that has an olefin component and is to be used as an emulsion polymer will have a molecular weight of about 20,000 or less.

In other embodiments of the invention, it may be desirable to deposit a metal coating layer on the skin layer (b) of the polymer substrate of the multilayer film structure, the metal coating layer being deposited on the surface of the skin layer (b) opposite the core layer. Application of a metal coating layer to the skin layer (b) of the polymer substrate of the multilayer film structure may be accomplished by conventional vacuum deposition, or any other metallization technique, such as electroplating or sputtering. The metal of the metal coating layer may be aluminum, or any other metal capable of being vacuum deposited, electroplated, or sputtered, such as, for example, gold, zinc, copper, or silver. The thickness of the deposited metal coating may be from about 5 to about 200 nanometers (nm), for example, from about 10 nm to about 100 nm, e.g. from about 30 to about 80 nm.

Before depositing the metal layer on the skin layer (b), the surface of the skin layer (b) may optionally be treated. The surface treatment may be flame treatment, corona discharge treatment, or plasma treatment. For example, the surface of the skin layer (b) may be treated to a surface tension level of at least about 35 dynes/cm, e.g. from about 38 to 55 dynes/cm, in accordance with ASTM Standard D2578-84. Because present skin layer (b) provides such an excellent metal-receiving surface, surface treatment of skin layer (b) is an optional step that may be skipped, thereby advantageously offering the opportunity to simplify the production process. If present, the second skin layer (c) may also optionally be surface treated.

The metal coating layer may itself be coated and/or laminated to another film to protect the metal surface. For example, a laminating film comprising a polymer having superior mechanical properties relative to the metal coating layer may be bonded to the metal coating layer using as an adhesive molten polymer having a lower melting point than the laminating polymer, e.g., low density polyethylene (LDPE). Alternatively, the laminating film may comprise a major layer of a polymer having superior mechanical properties and a minor layer of a polymer having a lower melting temperature than the polymer of the major layer, with the lamination being accomplished by pressing the surface of the laminating film containing the minor layer against the metallized film of the invention at a temperature high enough to render tacky the polymer of the minor layer. The methods and equipment necessary to accomplish the described bonding are well-known in the art

In general, the thickness of the polymer substrate of the multilayer film structure should be just enough to provide the necessary stiffness for adequate conveyance through a packaging machine, i.e. VFF&S, HFF&S, and multilane, etc., to package the product. For example, the polymer substrate may have a thickness of from about 0.5 to about 3.0 mil, for example, from about 0.7 to about 2.0 mil, e.g., from about 1.1 to about 1.5 mil.

The core layer may have a thickness of, for example, from about 75% to about 99% of the total polymer substrate thickness. The skin layer (b) may have a thickness of, for example, from about 1% to about 20% of the total polymer substrate thickness. The second skin layer (c), if present, may have a thickness of, for example, from about 1% to about 10% of the total polymer substrate thickness.

### EXAMPLES

The following six 3-layer coextruded film samples were produced and biaxially oriented on a tenter orientor to illustrate features and advantages of the present invention. Each sample had the following basic structure:

skin layer B—varied (see tables below);

core layer A—propylene homopolymer (FINA 3371);

skin layer C—copolymer sealant skin (CHISSO 7880 PP).

The total film gauge was 1 mil (25.4 μm), of which the core layer A represented 90% of the total film thickness, and each skin layer represented 5% of the total film thickness. Furthermore, the minimum seal temperature (MST) reported in the tables below represents the MST required to reach a 200 g/in seal.

### Examples 1 and 2 (Inventive)

TABLE 1

| | | | Ink Adhesion | | | | | |
|---|---|---|---|---|---|---|---|---|
| | | Corona | Sunprop | Pyroflex | Aquasurf | LC-23 white & | Metallization | MST |
| Ex. | Skin Layer B | treatment | white & red | white & red | white & red | Sungrip red | adhesion | (° F.) |
| 1 | AT-320 | Yes | Good | Good | Good | Good | Good | 170 |
| 2 | AT-320 | No | Good | Good | Good | Good | Fair-good | 170 |

AT-320 is ESCOR ethylene acid terpolymer resin from ExxonMobil.

### Examples 3-6 (Comparative)

TABLE 2

| | | | Ink Adhesions | | | | | |
|---|---|---|---|---|---|---|---|---|
| | | Corona | Sunprop | Pyroflex | Aquasurf | LC-23 white & | Metallization | MST |
| Ex. | Skin Layer B | treatment | white & red | white & red | white & red | Sungrip red | adhesion | (° F.) |
| 3 | 7510 | Yes | Good | Good | Fair | Good | Fair | 210 |
| 4 | 7510 | No | Poor | Poor | Poor | Poor | Poor | 210 |
| 5 | M-6030 | Yes | Good | Poor | Poor | Good | Good | n/a |
| 6 | M-6030 | No | Poor | Poor | Poor | Poor | Poor | n/a |

7510 is polypropylene terpolymer from CHISSO
M-6030 is polyethylene resin from LYONDELL

As is evident from the data presented in Tables 1 and 2, good ink adhesion was obtained by employing AT-320 ethylene acid terpolymer resin as skin layer B, even without surface treating (corona treating) the core layer. In addition, improved metal adhesion was obtained by employing AT-320 ethylene acid terpolymer resin as skin layer B. Finally, the use of AT-320 ethylene acid terpolymer resin as skin layer B provides a heat seal layer having a low minimum seal temperature (MST).

What is claimed is:

1. A multilayer film structure comprising a polymer substrate, the polymer substrate comprising:
(a) a core layer comprising a film-forming polyolefin, the core layer having a first side and a second side; and
(b) a skin layer on the first side of the core layer, wherein the skin layer comprises a film-forming ethylene acid terpolymer resin composition comprising (i) polyethylene, (ii) acrylic acid, methacrylic acid, or mixtures thereof, and (iii) alkyl acrylate, alkyl methacrylate, or mixtures thereof.

2. The multilayer film structure of claim 1, wherein the polymer substrate is produced by a process comprising the following steps (1) and (2):
(1) coextruding the core layer and the skin layer; and
(2) orienting the coextruded core layer and skin layer.

3. The multilayer film structure of claim 2, wherein the orientation in step (2) is biaxial orientation.

4. The multilayer film structure of claim 1, wherein the polymer substrate is produced by a process comprising:
(1) extruding and orienting the core layer in a machine direction; and
(2) extruding the skin layer onto the first side of the machine direction-oriented core layer and then orienting the skin layer and the machine direction-oriented core layer in a transverse direction.

5. The multilayer film structure of claim 1, wherein the polyolefin of the core layer is isotactic polypropylene.

6. The multilayer film structure of claim 1, wherein the polyolefin of the core layer is high density polyethylene.

7. The multilayer film structure of claim 1, wherein the ethylene acid terpolymer contains a total of from about 0.5 wt % to about 6 wt % of acrylic acid, methacrylic acid, or mixtures thereof, based on the total weight of the ethylene acid terpolymer.

8. The multilayer film structure of claim 1, wherein the ethylene acid terpolymer contains a total of from about 6 wt % to about 20 wt % of alkyl acrylate, alkyl methacrylate, or mixtures thereof, based on the total weight of the ethylene acid terpolymer.

9. The multilayer film structure of claim 1, wherein the skin layer (b) is a first skin layer and the core layer (a) has a second skin layer (c) on the second side of the core layer, and further wherein the polymer substrate comprises the core layer (a), the first skin layer (b), and the second skin layer (c).

10. The multilayer film structure of claim 9, wherein the second skin layer (c) is selected from the group consisting of ethylene homopolymers, propylene homopolymers, ethylene-propylene copolymers, propylene-butene-1 copolymers, ethylene-propylene-butene-1 terpolymers, and blends thereof.

11. The multilayer film structure of claim 1, wherein the skin layer (b) is surface-treated by flame treatment, corona discharge treatment, or plasma treatment.

12. The multilayer film structure of claim 11, wherein a metal layer is deposited on the skin layer (b) of the polymer substrate, the metal layer being deposited on the surface of the skin layer (b) opposite the core layer (a).
